(19) United States
(12) Patent Application Publication
(10) Pub. No.: US 2026/0244201 A1
(43) Pub. Date: Aug. 20, 2026

(54) MECHANICAL SYSTEM MAINTENANCE METHOD, MECHANICAL SYSTEM MAINTENANCE PROGRAM, AND MACHINE CONTROL DEVICE

(71) Applicant: FANUC CORPORATION, Yamanashi (JP)

(72) Inventor: Makoto SOMEYA, Yamanashi (JP)

(21) Appl. No.: 18/995,140

(22) PCT Filed: Oct. 12, 2022
(86) PCT No.: PCT/JP2022/038068

§ 371 Date: Jan. 16, 2025

(51) Int. Cl. G05B 23/02; H04L 9/40

(52) U.S. Cl. CPC G05B 23/0283; H04L 63/0428

(57) ABSTRACT

The present invention provides a mechanical system maintenance method that enables easy maintenance of a mechanical system without leading to a decrease in security, safety, or production efficiency. This mechanical system maintenance method involves performing, by using a remote device connected to a WAN, maintenance of a mechanical system that includes a machine and a machine control device that controls the machine. The mechanical system maintenance method further involves using the tethering function of a mobile terminal device to connect the machine control device to the WAN, enabling data transfer between the remote device and the machine control device connected via the WAN, and controlling the machine control device by using the remote device.

### RELATED APPLICATIONS

The present application is a National Phase of International Application No. PCT/JP 2022/038068 filed Oct. 12, 2022.

### FIELD

The present disclosure relates to a mechanical system maintenance method, a mechanical system maintenance program, and a machine control device.

### BACKGROUND

In recent years, a machine control device for controlling a machine such as a robot or CNC (Computer Numerical Control) machine tool has been generally connected to a LAN (Local Area Network) by a wired line such as an Ethernet (Registered Trademark) or a wireless line such as a Wi-Fi (Registered Trademark).

Such a machine control device is not directly connected to a WAN (Wide Area Network) such as the Internet. Specifically, when the machine control device is connected to a WAN (e.g., the Internet) at all times, security becomes fragile, further, since a malicious third party is connected thereto, a safety issue may result.

Incidentally, a mechanical system including a machine and a machine control device needs to be tested or inspected periodically or when some kind of trouble has occurred. Further, it is necessary to update an application program (program) such as a machine control device to improve a function thereof.

In the present specification, the wording of robot includes various robots including industrial robots, collaborative robots, and the like. Further, the wording of machine control device includes various machine control devices for controlling a machine such as a robot, CNC machine tool, and the like. In addition, the wording of maintenance includes periodically testing and inspecting a machine, a machine control device, etc., and updating a program executed by the machine control device or the like. It should be noted that the wording of mechanical system means a system including the machine, the machine control device, and the like.

Conventionally, various proposals have been made for a remote control technique for monitoring and operating a machine control device from a remote location.

### CITATION LIST

### Patent Literature

[PTL 1] Japanese Unexamined Patent Publication (Translation of PCT Application) No. 2020-502636 [PTL 2] Japanese Unexamined Patent Publication (Kokai) No. 2014-184519

### Non-Patent Literature

[NPLT 1] BIGLOBE, “What is tethering? An easy-to-understand explanation for beginners! ‘Shimugurashi’ BIGLOBE MOBILE”, BIGLOBE Top, Deals, BIGLOBE, TIPS 2017/06/06, [Searched on September 22, 2022], Internet, <URL:https://join.biglobe.ne.jp/mobile/sim/gurashi/what_is_tethering170608/>

### SUMMARY

### Technical Problem

As described above, the maintenance of a mechanical system is typically not performed from the surface of security or safety via the Internet. Alternatively, for example, a manufacturer of a mechanical system or a trader who has undergone maintenance (provider side of a mechanical system) dispatches a serviceman having expertise to the site to perform a maintenance operation.

As described above, when a serviceman is dispatched to a place where a machine and a machine control device are installed to perform maintenance on the mechanical system, not only are labor and cost required but also a reduction in production efficiency is also required to spend a corresponding time.

Therefore, it is desired to easily perform maintenance of a mechanical system (such as a machine and a machine control device) without causing security, safety, and reduction in production efficiency.

### Solution to Problem

According to an embodiment of the present invention, there is provided a mechanical system maintenance method for performing maintenance on a mechanical system including a machine and a machine control device for controlling the machine by a remote device connected to a WAN. The mechanical system maintenance method includes connecting the machine control device to the WAN by using a tethering function of a mobile terminal device; enabling data transfer between the remote device and the machine control device connected via the WAN; and controlling the machine control device by the remote device.

The objects and effects of the present invention will be recognized and obtained by using the components and combinations pointed out in the claims. Both the general description described above and the detailed description below are exemplary and descriptive and do not limit the invention described in the claims.

### BRIEF DESCRIPTION OF DRAWINGS

FIG. 1 is a diagram schematically depicting an example of a mechanical system to which a mechanical system maintenance method according to the present embodiment is applied.

FIG. 2 is a diagram for explaining an example of processing when implementing the mechanical system maintenance method according to the present embodiment.

FIG. 3 is a block diagram functionally depicting a main part in the configuration of an example of a machine control device according to the present embodiment.

FIG. 4 is a flowchart for explaining an example of processing in a mechanical system maintenance program according to the present embodiment.

### DESCRIPTION OF EMBODIMENTS

Hereinafter, examples of a mechanical system maintenance method, a mechanical system maintenance program, and a machine control device according to the present embodiment will be described in detail with reference to the accompanying drawings. In each of the drawings, the same or similar constituent elements are assigned the same or similar reference signs. Furthermore, the embodiments described below do not limit the technical scope and meaning of the terms of the invention set forth in the claims.

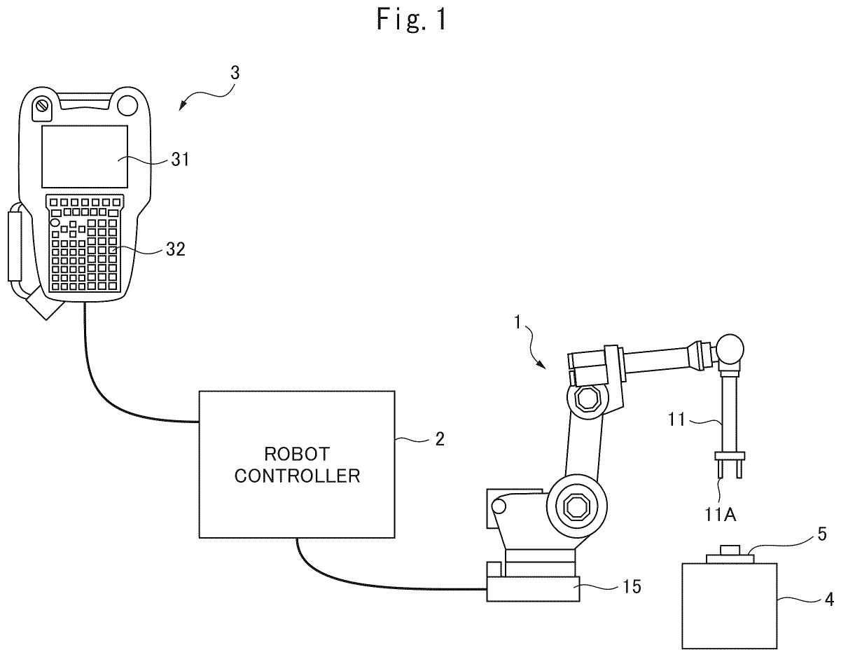

FIG. 1 is a diagram schematically depicting an example of a mechanical system to which a mechanical system maintenance method according to the present embodiment is applied, and specifically depicts an example of an industrial robot system. As depicted in FIG. 1, an industrial robot system 100, which is an example to which a mechanical system maintenance method according to the present embodiment is applied, includes an industrial robot (machine) 1, a robot controller (machine control device) 2, and a teach pendant 3.

A hand unit (end effector) 11A is provided at an end portion of an arm 11 of the industrial robot (robot) 1, and the hand unit 11A performs predetermined processing on a workpiece (object) 5 placed on a workbench 4. For example, a robot controller 2 controls the robot 1 based on a program (software program) installed in advance.

In this case, a camera (not shown) for capturing the workpiece 5 or the like may be attached to the vicinity of the hand unit 11A of the arm 11, and an image (video) including the workpiece 5 captured by the camera may be output to the robot controller 2. Further, various changes and modifications may be made in accordance with the type of machine to be applied and the processing required.

The teach pendant 3 includes a display screen 31 and an operation unit 32, and is connected to the robot controller 2 by wire. The teach pendant 3 may perform a predetermined operation on the robot 1 via the robot controller 2 by operating the operation unit 32 while an operator (teaching person) confirms an image of the display screen 31.

It should be noted that, in FIG. 1, the teach pendant 3 may be connected to the robot controller 2 by wire, but may also be connected to the robot controller 2 wirelessly. The teach pendant 3 is not limited to a special teach pendant as depicted in FIG. 1, but it is possible to use, for example, a tablet (tablet computer) connected to the robot controller 2 by wire or wirelessly.

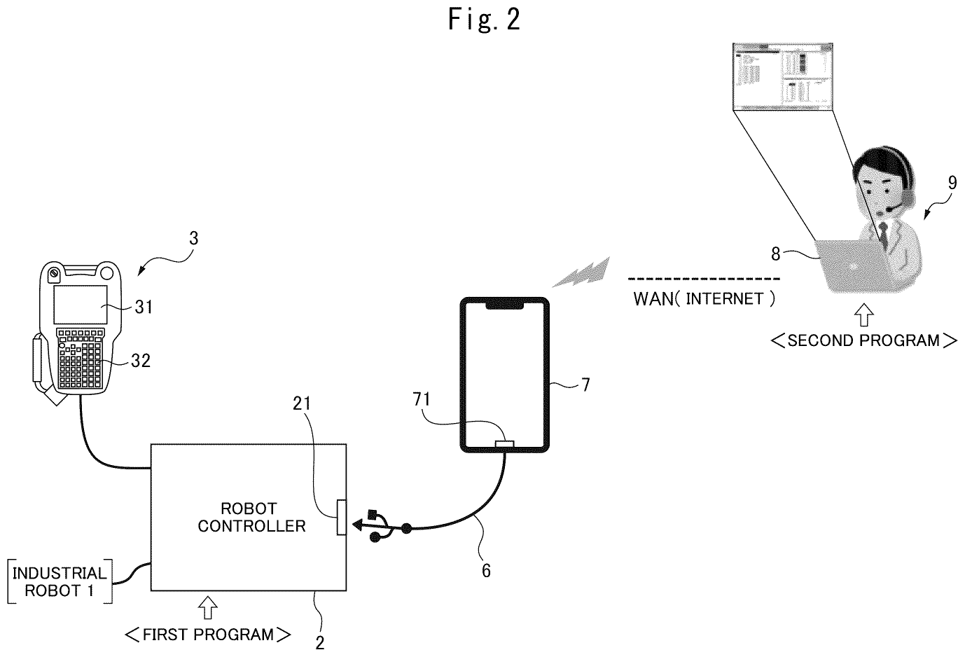

FIG. 2 is a diagram for explaining an example of processing when implementing the mechanical system maintenance method according to the present embodiment. In FIG. 2, a reference numeral 6 denotes a USB cable, 7 denotes a smartphone (mobile terminal device), 8 denotes a remote device, 9 denotes a serviceman, and 21 denotes a USB terminal.

In this case, the remote device 8 is provided, for example, in a service station of a manufacturer of the industrial robot system 100, a system provider side for performing maintenance thereof, and the like, and is connected to a WAN such as the Internet. It should be noted that the serviceman 9 is, for example, a system provider-side technician who works at the service station located far away from a factory or the like in which the industrial robot system 100 is installed, and has expertise related to the maintenance of the system.

As depicted in FIG. 2, when performing maintenance of the industrial robot system 100, for example, a USB cable 6 is used to connect the robot controller 2 to a smartphone 7. Specifically, the USB cable 6 connects a USB (e.g., Type-A) terminal 21 of the robot controller 2 and a USB (e.g., Type-C) or Lightning (Registered Trademark) terminal 71 of the smartphone 7, and connects to the WAN using a USB tethering function of the smartphone 7.

In this case, the tethering function of the smartphone 7 that connects the robot controller 2 to the WAN is not limited to USB tethering, and it is possible to use Wi-Fi (Registered Trademark) tethering or Bluetooth (Registered Trademark) tethering. It should be noted that USB tethering by using the USB cable 6 (wired) may be preferable, since USB tethering is less likely to be affected by noise and the connection is more stable than tethering wirelessly.

Further, the smartphone 7 itself includes a subscriber identity module card (SIM card), and is not limited to being directly connected to the WAN, but may be connected to the WAN via a network such as Wi-Fi (Registered Trademark). In addition, the smartphone 7 may be a mobile terminal device including a tethering function such as a tablet or a notebook computer.

As described above, the remote device 8 includes a communication function and may be connected to the Internet (WAN). Further, when the industrial robot system 100 is maintained, for example, an operator of the industrial robot system uses USB tethering function of the smartphone 7 to connect the robot controller 2 to the Internet. Specifically, the USB cable 6 connects the USB terminal 21 of the robot controller 2 to a USB terminal 71 of the smartphone 7, and temporarily connects the robot controller 2 to the Internet.

In this case, the robot controller 2 is connected to, for example, a LAN in a factory or a company in which the industrial robot system 100 is installed. Therefore, when the robot controller 2 exchanges data with the remote device 8 via USB tethering of the smartphone 7, for example, it is necessary to perform reliable communication through a firewall set in the LAN.

Specifically, it is necessary to transmit and receive data by security-protected encrypted communication between the robot controller 2 and the remote device 8. Therefore, for example, a predetermined program (first program) is installed on the robot controller 2, and the first program is preferably executed in the robot controller 2. Further, for example, a predetermined program (second program) is installed on the remote device 8, and it is more preferable to execute the second program in the remote device 8.

It should be noted that an OS (Operating System) of the robot controller 2 and the remote device 8 may be, for example, various kinds of OS such as Windows (Registered Trademark), Linux (Registered Trademark) or a dedicated OS. Therefore, the first and second programs executed by the robot controller 2 and the remote device 8 may be appropriately selected based on the respective OS, the security software to be used, the firewall, and the like. The robot controller 2 may be connected only to a predetermined specific remote device 8, so that security or the like may be further improved.

In this way, via USB tethering of the smartphone 7, data transfer by the security-protected encrypted communication between the robot controller 2 and the remote device 8 is temporarily established. In this state, for example, the industrial robot system 100 may be maintained by the remote device 8 of the service station far away from the installation location of the industrial robot system 100.

It should be noted that the maintenance of the industrial robot system 100 by the remote device 8 may include, for example, a test or inspection, and a simulation of the industrial robot 1, the robot controller 2, and the teach pendant 3. The maintenance of the industrial robot system 100 by the remote device 8 may also include, for example, an update of a program executed by the robot controller 2 and the teach pendant 3.

Further, for example, the operation record (log) of the industrial robot 1 stored in the memory (24) of the industrial robot 1 and the suction of various data may be included in the maintenance of the industrial robot system 100 by the remote device 8. As described above, the maintenance of the industrial robot system 100 by the remote device 8 may include various maintenance operations performed by dispatching a serviceman at an installation location of the industrial robot system 100.

As described above, in the mechanical system maintenance method according to the present embodiment, for example, maintenance may be performed by a remote device via USB tethering of a smartphone. Further, since security-protected encrypted communication between a robot controller and the remote device is performed via USB tethering of a smartphone, installation and setting of a router for connecting to the Internet may be eliminated.

Specifically, in the mechanical system maintenance method according to the present embodiment, the security-protected encrypted communication between the machine control device and the remote device is temporarily established using USB tethering or the like of a smartphone that may be easily used. In the temporarily established security-protected encrypted communication between the machine control device and the remote device, various maintenance operations on the mechanical system side may be performed from the remote device side.

Therefore, using the mechanical system maintenance method according to the present embodiment, a maintenance operation may be performed from the service station or the like on the provider side of the mechanical system without dispatching a serviceman to a place where the mechanical system is installed.

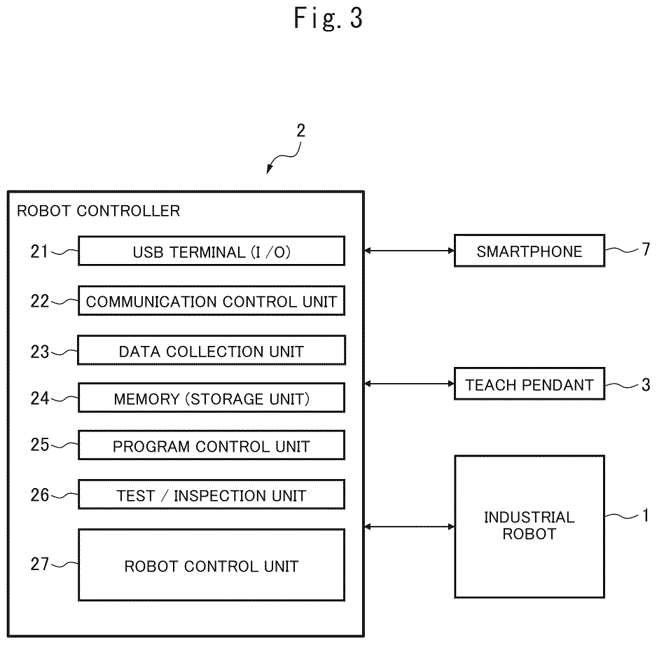

FIG. 3 is a block diagram functionally depicting a main part in the configuration of an example of a machine control device according to the present embodiment. As depicted in FIG. 3, the machine control device (robot controller) 2 includes a USB terminal (I/O) 21, a communication control unit 22, a data collection unit 23, a memory (storage unit) 24, a program control unit 25, a test/inspection unit 26, and a robot control unit 27.

The robot control unit 27 controls the industrial robot 1 to cause the industrial robot 1 to perform a predetermined work. In this case, the robot control unit 27 may be also used to control the industrial robot 1 based on an instruction from the teach pendant 3. Further, each of the communication control unit 22, the data collection unit 23, the program control unit 25, the test / inspection unit 26 and the robot control unit 27 in the robot controller 2 may carry out various functions in accordance with a program executed by an arithmetic processing unit (CPU: not shown).

As described above, the USB terminal 21 is connected to a USB terminal 71 of the smartphone 7 by the USB cable 6, and connects the robot controller 2 to the Internet by USB tethering function of the smartphone 7. The USB terminal 21 of the robot controller 2 is not limited to the use for performing USB tethering of the smartphone 7, and may be used to connect to various other devices.

The communication control unit 22 controls communication with a remote device 8 connected to the Internet via, for example, USB tethering of the smartphone 7. It should be noted that the communication control unit 22 also controls, for example, communication between an upper control device and the like for controlling the industrial robot system 100 via the LAN.

The data collection unit 23 collects, for example, operation records, various data, and the like of the industrial robot 1, and stores the collected data in the memory 24. The data collected by the data collection unit 23 is not limited to the data of the industrial robot 1 itself, and may be, for example, environmental conditions such as temperature, humidity and other various information.

The memory 24 includes, for example, a volatile memory such as a dynamic random access memory (DRAM), and a non-volatile memory such as a programmable read only memory (PROM) or a flash memory. In this case, the data collected by the data collection unit 23 and the program executed by the robot controller 2 may be stored in the flash memory, for example, and hold the data even if a power supply of the industrial robot system 100 is cut off

The program control unit 25 controls the program executed by the robot controller 2, and updates the program of the robot controller 2 by the remote device 8 via USB tethering function of the smartphone 7. It should be noted that the teach pendant 3 includes an arithmetic processing unit (CPU) and a memory, and when the teach pendant 3 executes a unique program, the program control unit 25 may control an update of the program of the teach pendant 3.

The test/inspection unit 26 performs a test and inspection of the industrial robot system 100 periodically or when some kind of trouble has occurred. Specifically, the test/inspection unit 26 tests and inspects the industrial robot 1, the robot controller 2, and the teach pendant 3 by the remote device 8, for example, via USB tethering function of the smartphone 7. The data of the result of the test and inspection performed by the test/inspection unit 26 is transmitted to the remote device 8 in real time via, for example, USB tethering function of the smartphone 7.

As described above, the data transfer between the remote device 8 and the robot controller 2 connected via the Internet by USB tethering function of the smartphone 7 is performed by security-protected encrypted communication. In this case, the data transfer by the security-protected encrypted communication may be performed by executing the first program installed in the robot controller 2.

Further, the data transfer by the security-protected encrypted communication may be performed by executing both the first program installed in the robot controller 2 and the second program installed in the remote device 8. It should be noted that the first and second programs executed by the robot controller 2 and the remote device 8 described above may be selected as appropriate ones based on the OS, the security software to be used, the firewall, and the like. In addition, the robot controller 2 may be connected only to a predetermined specific remote device 8 to further improve security or the like.

Further, the remote device 8 controls the robot controller 2, for example, the operation of the industrial robot 1 by the robot controller 2 may be simulated by the remote device 8 via USB tethering function of the smartphone 7. Specifically, for example, the robot controller 2 may be accessed from the remote device 8 via USB tethering function of the smartphone 7, and the screen of the teach pendant 3 may be displayed on the remote device 8 to operate the industrial robot 1.

In the above descriptions, the robot controller 2 is not limited to controlling an industrial robot 1, but may control various robots including a cooperative robot, and various machine control devices that control a machine such as a CNC machine tool. Therefore, in the machine control device according to the present embodiment, the same maintenance operation may be performed from the service station or the like on the provider side of the mechanical system without dispatching the serviceman to a place where the mechanical system is installed.

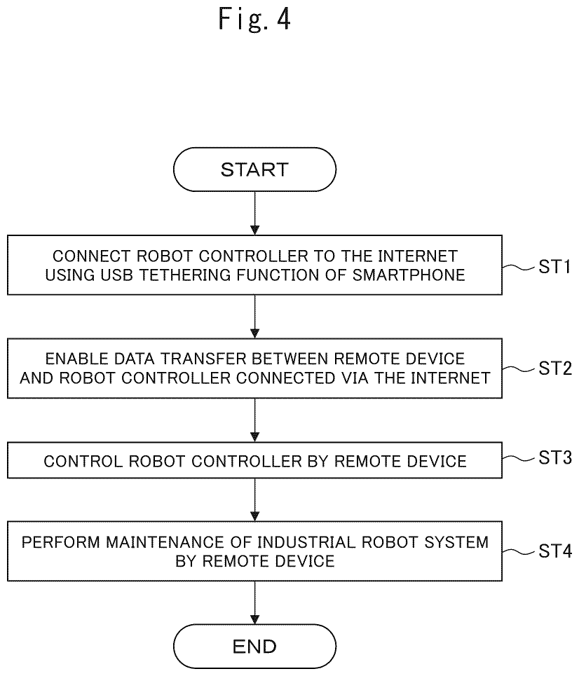

FIG. 4 is a flowchart for explaining an example of processing in a mechanical system maintenance program according to the present embodiment. This example of the mechanical system maintenance program may be executed by, for example, an arithmetic processing unit that carries out each function of the robot controller 2 described with reference to FIG. 3.

As depicted in FIG. 4, when the example of processing in the mechanical system maintenance program according to the present embodiment is started (START), in step ST1, the robot controller 2 is connected to the Internet using USB tethering function of the smartphone 7.

In this case, the robot controller 2 is connected to the Internet using USB tethering function of the smartphone 7, when it is necessary to perform a test or inspection, for example, periodically or when some kind of trouble has occurred. Alternatively, the programs of the robot controller 2 and the teach pendant 3 are updated, or when various data stored in the memory 24 of the robot controller 2 are retrieved on the remote device 3 side.

It should be noted that the robot controller 2 is temporarily connected to the Internet using USB tethering function of the smartphone 7, for example, an operator or the like in a factory in which the industrial robot system 100 is installed. Therefore, in the factory or the like, the operator may connect the robot controller 2 to the Internet using USB tethering function of the smartphone 7.

Next, the process proceeds to step ST2, wherein data transfer between the remote device 8 and the robot controller 2 is enabled via the Internet. Specifically, USB tethering function of the smartphone 7 is used to temporarily establish a security-protected encrypted communication between the robot controller 2 and the remote device 8.

This security-protected encrypted communication is established as described above, for example, by executing a first program in the robot controller 2 and/or a second program in the remote device 8.

Further, the process proceeds to step ST3, wherein the robot controller 2 is controlled by the remote device 8 via the temporarily established security-protected encrypted communication between the robot controller 2 and the remote device 8. Furthermore, in step ST4, various maintenance operations of the industrial robot system 100 may be performed from the remote device 8 via the temporarily established security-protected encrypted communication between the robot controller 2 and the remote device 8.

As described above, the maintenance operation of the industrial robot system 100 may be performed, for example, from a service station away from the factory via the remote device 8 by a serviceman 9 having expert knowledge. The detailed processing in each of the above steps ST1 to ST4 is duplicated in the explanations already given with reference to FIG. 2 and FIG. 3, so that the explanations thereof will be omitted.

It should be noted that the mechanical system maintenance program according to the present embodiment described above may be provided by being recorded in a computer-readable non-transitory recording medium or non-volatile semiconductor memory, or may be provided via wired or wireless. In this case, as a computer-readable non-temporary recording medium, for example, an optical disk such as a CD-ROM (Compact Disc Read Only Memory) or a DVD-ROM, or a hard disk device, and the like may be considered. Further, a PROM (Programmable Read Only Memory), a Flash Memory (Registered Trademark), and the like are conceivable as nonvolatile semiconductor memory devices. In addition, the distribution from the server device may be provided via a wired or wireless WAN (Wide Area Network), LAN (Local Area Network), or via the Internet.

As described in detail above, in accordance with the mechanical system maintenance method, mechanical system maintenance program, and machine control device of the present embodiment, it is possible to easily perform maintenance of a mechanical system without causing security, safety, and reduction in production efficiency.

Although the embodiments of the present disclosure have been described in detail, the present disclosure is not limited to the individual embodiments described above. These embodiments include various additions and replacements without departing from the gist of the invention, or without departing from the idea and spirit of the invention derived from the content described in the claims and equivalents thereof, modification, partial deletion, and the like are possible. For example, in the above-described embodiments, the order of each operation and the order of each process are shown as an example, and are not limited to these. The same applies when numerical values or equations are used in the description of the above-described embodiments.

Regarding the above-described embodiments and variations, the following are further disclosed.

### Appendix 1

A mechanical system maintenance method for performing maintenance of a mechanical system (100) including a machine (1) and a machine control device (2) for controlling the machine (1) by a remote device (8) connected to a WAN, the mechanical system maintenance method comprising:
connecting the machine control device (2) to the WAN by using a tethering function of a mobile terminal device (7);
enabling data transfer between the remote device (8) and the machine control device (2) connected via the WAN; and
controlling the machine control device (2) by the remote device (8).

### Appendix 2

The mechanical system maintenance method according to appendix 1, wherein
the connecting of the machine control device (2) to the WAN is performed by a USB tethering that connects a USB terminal (21) provided in the machine control device (2) to the mobile terminal device (7) by wire.

### Appendix 3

The mechanical system maintenance method according to appendix 1 or 2, wherein
the data transfer between the remote device (8) and the machine control device (2) connected via the WAN is performed by a security-protected encrypted communication.

### Appendix 4

The mechanical system maintenance method according to appendix 3, wherein
the data transfer by the security-protected encrypted communication is performed by executing a first program installed in the machine control device (2).

### Appendix 5

The mechanical system maintenance method according to appendix 4, wherein
the data transfer by the security-protected encrypted communication is further performed by executing a second program installed in the remote device (8).

### Appendix 6

The mechanical system maintenance method according to any one of appendixes 1 to 5, wherein
the controlling the machine control device (2) by the remote device (8) is performed by simulating an operation of the machine (1) based on the mechanical control device (2) by the remote device (8).

### Appendix 7

The mechanical system maintenance method according to any one of appendixes 1 to 6, wherein
maintenance of the mechanical system (100) performed by the remote device (8) and includes a test and inspection of the machine control device (2) and the machine (1), and an update of a program executed by the machine control device (2).

### Appendix 8

The mechanical system maintenance method according to any one of appendixes 1 to 7, wherein
a teach pendant (3) configured to operate the machine (1) is connected to the machine control device (2), and
maintenance of the mechanical system (100) performed by the remote device (8) and includes a test and inspection of the teach pendant (3), and an update of a program executed by the teach pendant (3).

### Appendix 9

The mechanical system maintenance method according to any one of appendixes 1 to 8, wherein
the machine control device (2) includes a memory (24) configured to collect various data related to the machine (1), and store the collected various data, and
maintenance of the mechanical system (100) performed by the remote device (8) includes a suction of the various data stored in the memory (24).

### Appendix 10

The mechanical system maintenance method according to any one of appendixes 1 to 9, wherein
the machine control device (2) is configured to be connectable only to a predetermined specific remote device (8).

### Appendix 11

The mechanical system maintenance method according to any one of appendixes 1 to 10, wherein
the remote device (8) is provided in a service station of a provider side of the mechanical system (100) including the machine (1) and the machine control device (2).

### Appendix 12

A mechanical system maintenance program for causing at least one arithmetic processing unit to execute the mechanical system maintenance method according to any one of appendixes 1 to 11.

### Appendix 13

A machine control device for controlling a machine comprising an arithmetic processing unit and a memory (24), wherein
the machine control device (2) causes the arithmetic processing unit to execute the mechanical system maintenance program according to appendix 12.

1. A mechanical system maintenance method for performing maintenance of a mechanical system including a machine and a machine control device for controlling the machine by a remote device connected to a WAN, the mechanical system maintenance method comprising:
connecting the machine control device to the WAN by using a tethering function of a mobile terminal device;
enabling data transfer between the remote device and the machine control device connected via the WAN; and
controlling the machine control device by the remote device.

2. The mechanical system maintenance method according to claim 1, wherein the connecting of the machine control device to the WAN is performed by a USB tethering that connects a USB terminal provided in the machine control device to the mobile terminal device by wire.

3. The mechanical system maintenance method according to claim 1, wherein
the data transfer between the remote device and the machine control device connected via the WAN is performed by a security-protected encrypted communication.

4. The mechanical system maintenance method according to claim 3, wherein
the data transfer by the security-protected encrypted communication is performed by executing a first program installed in the machine control device.

5. The mechanical system maintenance method according to claim 4, wherein
the data transfer by the security-protected encrypted communication is further performed by executing a second program installed in the remote device.

6. The mechanical system maintenance method according to claim 1, wherein
the controlling the machine control device by the remote device is performed by simulating an operation of the machine based on the mechanical control device by the remote device.

7. The mechanical system maintenance method according to claim 1, wherein
maintenance of the mechanical system performed by the remote device and includes a test and inspection of the machine control device and the machine, and an update of a program executed by the machine control device.

8. The mechanical system maintenance method according to claim 1, wherein
a teach pendant configured to operate the machine is connected to the machine control device, and
maintenance of the mechanical system performed by the remote device and includes a test and inspection of the teach pendant, and an update of a program executed by the teach pendant.

9. The mechanical system maintenance method according to claim 1, wherein
the machine control device includes a memory configured to collect various data related to the machine, and store the collected various data, and
maintenance of the mechanical system performed by the remote device includes a suction of the various data stored in the memory.

10. The mechanical system maintenance method according to claim 1, wherein
the machine control device is configured to be connectable only to a predetermined specific remote device.

11. The mechanical system maintenance method according to claim 1, wherein
the remote device is provided in a service station of a provider side of the mechanical system including the machine and the machine control device.

12. A computer readable non-transitory tangible medium for storing a mechanical system maintenance program for causing at least one arithmetic processing unit to execute the mechanical system maintenance method according to claim 1.

13. A machine control device for controlling a machine comprising an arithmetic processing unit and a memory, wherein
the machine control device causes the arithmetic processing unit to execute the mechanical system maintenance program stored in the computer readable non-transitory tangible medium according to claim 12.
